(19) United States
(12) Patent Application Publication
(10) Pub. No.: US 2008/0138528 A1
(43) Pub. Date: Jun. 12, 2008

(54) Method for Depositing Palladium Layers and Palladium Bath Therefor

(75) Inventors: Andreas Gross, Pforzheim (DE); Andreas Tieffenbacher, Murrhardt (DE)

Correspondence Address: KALOW & SPRINGUT LLP, 488 MADISON AVENUE, 19TH FLOOR, NEW YORK, NY, 10022, US

(73) Assignee: UMICORE GALVANOTECHNIK GMBH, Schwabisch Gmund (DE)

(21) Appl. No.: 11/813,539

(22) PCT Filed: Jan. 11, 2006
(86) PCT No.: PCT/EP06/00164

§ 371 Date: Nov. 2, 2007

(30) Foreign Application Priority Data
Jan. 12, 2005 (DE) 10 2005 001 388.0

(51) Int. Cl. B05D 1/18; C09D 5/00

(52) U.S. Cl. 427/436; 106/1.28

(57) ABSTRACT

Copper conductor tracks of circuit boards require a coating which has good corrosion resistance and is suitable for multiple solderability and bondability to enable them to be provided with electronic components. These properties are fulfilled by a layer system which has an intermediate layer of autocatalytically deposited nickel on which a palladium layer has been deposited by charge exchange. To ensure reliable adhesive strength, low porosity and a good homogeneity, the bath for deposition of the palladium layer contains a copper compound. To passivate the palladium layer, the layer system can be provided with a final layer of gold deposited by charge exchange and/or autocatalytically.

The invention relates to a process for the deposition of palladium layers on metal surfaces and a bath for carrying out the process.

In the electronics industry, large numbers of circuit boards having an organic basis (printed circuits) and inorganic basis (glass/ceramic substrates) are used. The electrical connection between the electronic components on the boards is usually established by means of copper conductor tracks located on the circuit boards. To obtain a reliable connection between the electronic components and the metallic contact areas on the plane of the circuit board, it is necessary to provide the contact areas with one or more additional metallic and/or organic covering layers. Here, the physicochemical properties of the coating materials are utilized to meet the demands in terms of processability for component assembly and the functional properties of the complete group of components made of the overall layer structure.

Various methods of producing these final layers have become known. The choice of a particular process depends on the required function and the costs of the process. The deposition of metals from solutions containing metal salts requires negative electric charges which convert the positively charged metal ion into the zero-valent state, i.e. the metallic form, by reduction. In the case of electrolytic metal deposition or electroplating, this occurs with the aid of an external current source.

In industrial practice, not only electrolytic processes but also, in particular, electroless coating processes have become established for the deposition of metallic final surfaces. The charges necessary for deposition are provided either by charge exchange reactions or come from chemical reducing agents. Electroless coating processes thus do not require an external power connection. The layout of the circuit can thus be configured flexibly. In addition, owing to the more uniform layer distribution of processes which do not involve an external current, denser and more complex circuit designs can in principle be realized more readily.

Owing to their importance to the present invention, the two electroless coating processes, namely coating by means of charge exchange and coating by means of autocatalysis (chemical reduction) together with the terms most widely used for them are compared in table 1:

TABLE 1
Comparison of deposition processes which do not involve an external
current for the example of palladium
Deposition by

| | |
|---|---|
| Autocatalysis | Charge exchange |

Deposition reaction

| | |
|---|---|
| Pd⁺ + R → Pd⁰ + R⁺ | Pd⁺ + Me^{o} → Pd⁰ + Me⁺ |
| R: organic or inorganic, non-metallic | Me^{o}: less noble than palladium, is |
| reducing agent | substrate or auxiliary anode e.g. |
| | Cu, Ni or Ag |

German term

| | |
|---|---|
| chemisch Palladium | Ladungsaustauschverfahren |
| stromlos Palladium | Sudpalladium |
| reduktiv Palladium | Zementationsverfahren |
| autokatalytisch Palladium | Verdrängungsverfahren |
| | (Ionenaustauschverfahren) |

English term

| | |
|---|---|
| electroless palladium | immersion palladium |
| autocatalytic palladium | strike palladium |
| | displacement reaction |

For the purposes of the present invention, the terms deposition by autocatalysis and deposition by charge exchange are used for the two processes.

In the case of deposition by means of autocatalysis, the positive metal ions present in the coating bath are reduced by an additional component R having a reducing action and deposited.

When autocatalytic coating baths are used, there is always a risk of spontaneous decomposition of the electrolyte by reduction of the metal ions even while the bath is being made ready. Attempts are made to counter this spontaneous decomposition by addition of suitable bath components (complexing agents+stabilizers) and set an optimum ratio of bath stability to activity of the electrolyte.

In the ideal case, metal ions are reductively deposited exclusively on the metallic functional surfaces to be coated. Undesirable spontaneous decomposition reactions, i.e. metal deposition on non-functional surfaces such as the vessel wall, heating facilities and piping and also on non-metallic constituents of the circuit boards (exposed base material surfaces or organic covering materials such as soldering masks) are suppressed.

In the charge exchange process, no reducing agents are required for deposition of the metal ions in the electrolyte, unlike the case of the autocatalytic process. The electrons required for reduction of the metal ions come from the substrate material or the intermediate layer. The less noble material of the substrate or the intermediate layer (e.g. Cu, Ni, Ag and the corresponding alloys) dissolves during the coating process and the corresponding metal ions go into solution, while the more noble metal present as ion in solution takes up the electrons liberated and deposits in metallic form on the substrate material or the intermediate layer. An essential aspect of this process is the fact that sooner or later charge exchange ceases when a sufficiently thick and dense layer of the more noble metal has been deposited, so that the substrate material cannot dissolve further. The maximum layer thickness which can be usually achieved ranges from a few nm to about 1 μm, depending on the type and surface quality of the substrate material and on the composition of the electrolyte.

The most widespread electroless coating processes for final surfaces on high-quality circuit boards having the required multiple solderability are tin and silver deposited by charge exchange and the autocatalytic nickel (alloy)/strike gold process. The balance of the process- and materials-specific advantages and disadvantages of the individual systems plays a decisive role in the selection and use of one of these processes on the production scale.

However, if the final surfaces of the circuit boards, the element joining the group of electronic components on the substrate side, have to meet increased demands in respect of function and reliability of the connection, alternative layer systems have to be used. Thus, evermore complex and more highly integrated electronic components often require a combination of various construction and assembly techniques on the same circuit board surface in order to be able to optimize electrical disentanglement on the subsequent connection planes. Apart from processability of the final layer for different and multi-use soldering processes (wave and reflow) and suitability for adhesive bonding, suitability for bonding with aluminum wire and/or gold wire is also particularly important.

Wire bonding is a micro pressure welding process in which identical or different materials are joined to one another in the solid state by means of pressure and also temperature and/or ultrasound.

A coating system suitable for this purpose usually comprises a layer structure of nickel or nickel alloys as diffusion barrier and final layers comprising noble metals, especially layers based on gold, silver and/or palladium.

To meet the requirement profile for the combination of soldering and bonding on a surface, there are at present two coating processes which have been tested on the market and by means of which it is possible to reliably process aluminum wire by means of ultrasonic bonding and also gold wire by means of thermosonic bonding:
autocatalytic (chemical) nickel/strike gold followed by autocatalytically deposited gold to thicken the gold layer to the required layer thickness (in general 0.5 μm of gold in order to be able to produce reliable gold wire bonding).
Autocatalytic nickel followed by autocatalytically deposited palladium (up to 0.5 μm) with subsequent deposition of gold by means of a charge exchange process to protect the palladium against chemical change as a result of its high reactivity.

Both layer systems have a multifunctional surface having good solderability and bondability both for load-bearing power leads comprising thick aluminum wire and for thin aluminum or gold wire for connecting of the IC (chip) on the support material. However, the use of autocatalytic noble metal processes (gold or palladium) means a complicated process for the producer of the layers. Furthermore, the two layer systems require relatively thick noble metal layers, which has a corresponding effect on the costs of the overall layer system.

Autocatalytic processes for producing multifunctional surfaces on printed circuits additionally have the following disadvantages:
high manufacturing complexity in order to realize reliable bath handling with high-quality coating results.
The composition of the electrolyte is relatively complex due to the reaction mechanisms which occur. The resulting costs for working with these autocatalytic processes are correspondingly high because of the use and consumption of the chemicals employed.
To achieve the required multifunctional layer properties (in particular reliable thermosonic bonding with gold wire), high layer thicknesses have been specified by the end customers (=component assemblers). The use of noble metals as functional layers has a considerable influence on the overall process costs.

EP 0 701 281 A1 describes a substrate having a bondable coating for the bonding of gold wires by means of the thermosonic process. The coating comprises a combination of a nickel or nickel alloy layer, a palladium-containing layer and a gold or gold alloy layer. The layers are deposited chemically (electrolessly) or by electroplating. The deposition processes are not specified more precisely.

EP 1 319 734 A1 describes a coating process for the electroless coating of a metal with a firmly adhering gold layer. Good adhesion of the gold layer is ensured by precoating of the metal with a palladium layer. The palladium layer is, for example, deposited by charge exchange from an immersion bath. Such immersion or strike baths are described, for example, in the U.S. Pat. No. 5,178,745 and U.S. Pat. No. 5,212,138 and are used for the deposition of bonding layers and for initiation of a subsequent electroless deposition of nickel.

It is an object of the present invention to provide a process for the deposition of palladium layers on functional metallic surfaces, which are suitable for the combination of various construction and assembly techniques on the same substrate surface and avoid the abovementioned disadvantages of the prior art.

The problem is solved by a process for applying a functional layer to a substrate metal comprising a nickel or nickel alloy layer, a palladium layer and, if desired, a gold or gold alloy layer, wherein the nickel or nickel alloy layer is deposited autocatalytically, the palladium layer is deposited by charge exchange and the final gold or gold alloy layer is once again deposited by charge exchange or autocatalytically, with the bath for deposition of the palladium layer comprising not only a palladium salt but also an inorganic compound of at least one of the elements copper, thallium, selenium and tellurium, preferable copper.

The substrate metal usually forms the conductor tracks of an electronic circuit board and is usually selected from among copper and copper alloys. However, any other conductive material such as silver or a silver alloy is in principle also possible as substrate material.

For soldering applications in which the thermal stressability of the surface and suitability for aluminum wire bonding have to meet the highest requirements, layer structures according to the invention consisting only of an autocatalytically applied nickel or nickel alloy layer and the palladium layer from the charge exchange process as final layer without final gilding have also been tested successfully. An advantage here is the protection of the nickel against oxidation by the palladium which has a good diffusion barrier action.

The proposed process dispenses with an autocatalytic process step in the deposition of the noble metal. Instead, the palladium is deposited on the nickel or nickel alloy intermediate layer by means of a purely charge exchange process using a newly formulated palladium bath.

The deposition of palladium by charge exchange from an aqueous solution is known. In general, the solutions are composed of an inorganic or organic acid and the corresponding palladium salt. In the electronics field, they are preferably used for activating copper and silver layers in order to initiate autocatalytic deposition of nickel carried out subsequently.

However, these known palladium baths are not suitable for deposition of a palladium layer having the required multifunctionality on an existing nickel alloy layer (applied autocatalytically). Instead, deposition of palladium on nickel or its alloys by charge exchange from the known baths results in deposition of inhomogeneous, highly porous layers which do not adhere and whose quality does not meet requirements in respect of solderability, bondability or improvement of the corrosion behavior.

It has surprisingly been found that the requirements in respect of multiple solderability and bondability can only be met when not only a palladium salt but also an inorganic compound of at least one of the elements copper, thallium, selenium and tellurium are added to the palladium bath. Preference is given to using a copper compound, in particular copper sulfate. As a result of this additive, firmly adhering, optically homogeneous, thin palladium layers which have a low porosity are obtained on the intermediate layer, generally autocatalytic nickel. However, the additive itself cannot be detected in the finished layer system by means of the standard analytical methods (e.g. SEM-EDX).

The palladium bath for the deposition of the palladium layer by charge exchange preferably comprises at least one palladium salt having an inorganic or organic anion selected from the group consisting of palladium sulfate, palladium nitrate, palladium chloride and palladium acetate and also an acid matrix comprising at least one mineral acid selected from the group consisting of sulfuric acid, nitric acid, phosphoric acid and hydrochloric acid. Preference is given to using chlorine-free components.

The activity of the electrolyte and its deposition behavior in a quality necessary for reliable function of the surface can be adjusted by means of the molar ratio of palladium to the mineral acids in the electrolyte. Good results are obtained at a molar ratio of palladium to the mineral acids of from 1:500 to 1:2000.

The deposition of the palladium layer can be carried out at a temperature of the coating bath in the range from room temperature to 70° C., preferably from 25 to 50° C. The pH of the bath depends on the chosen molar ratio of palladium to the mineral acids. At the molar ratios indicated above, the pH is always in the acid range from 0 to 4 and is thus readily compatible with the materials of the circuit boards. The pH is preferably in the range from 0 to 2.

The thickness of the palladium layer which forms depends on the time for which the palladium bath acts on the substrate. Palladium layers having a low porosity and good homogeneity can be deposited using contact times of from 1 to 20 minutes. The layer thickness here is in the range from a few nanometers to 100 nm, preferably from 10 to 80 nm, in particular from 10 to 40 nm.

In an embodiment of the palladium bath for the deposition of a palladium layer by charge exchange on a nickel or nickel-phosphorus alloy layer, the bath preferably has the following composition:
a) from 10 to 1000 mg/l, in particular from 10 to 500 mg/l, of palladium from at least one palladium salt having an inorganic or organic anion selected from the group consisting of palladium sulfate, palladium nitrate and palladium acetate,
b) from 5 to 500 g/l, in particular from 10 to 200 g/l, of at least one mineral acid selected from the group consisting of sulfuric acid, nitric acid and phosphoric acid and
c) from 1 to 200 mg/l, in particular from 2 to 50 mg/l, of at least one of the elements copper, thallium, selenium and tellurium from inorganic compounds of these elements.

To improve the stability of the palladium bath, particular components which have a complexing action on nickel and/or palladium can be added to the bath. Examples of such additives to the bath are various hydroxycarboxylic acids with or without a functional mercapto group, e.g. citric acid, tartaric acid or thioglycolic acid, particular amine compounds such as triethanolamine, tren or penten and also the known EDTA derivatives (for example the known Titriplex compounds) for the complexation of metal ions. The complexing agent is preferably added to the palladium bath in a concentration of from 1 to 200 g/l, in particular from 2 to 50 g/l.

Numerous studies of the soldering and bonding behavior even after thermal ageing of the circuit boards prior to the actual assembly process have impressively demonstrated that the layer system comprising a nickel or nickel alloy intermediate layer with palladium deposited thereon by charge exchange and, if desired, a final thin gold coating having a thickness of less than 0.1 μm produced on copper conductor tracks by the process of the invention has excellent resistance to oxidation and mutual diffusion between the individual layers. This makes the layer system deposited according to the invention particularly suitable for thermosonic bonding with gold wire.

The optional gold layer having a purity of greater than 99% can be deposited from a conventional charge exchange bath and additionally be thickened further to a desired thickness by means of known autocatalytic processes.

Additional studies carried out by the inventors on the effect of pollutant gases on the corrosion behavior of the layer systems deposited according to the invention show a significant improvement in the results when using the charge exchange process for palladium on autocatalytic nickel compared to pure autocatalytic nickel/gold layers from the prior art.

The thin palladium layer applied to nickel by charge exchange according to the invention has a low porosity and forms a good diffusion barrier against diffusion of nickel into the optional gold layer. In contrast, without the addition of inorganic compounds of at least one of the elements copper, thallium, selenium and tellurium to the charge exchange bath, satisfactory adhesive and barrier action of the palladium layer are not achieved.

### EXAMPLE 1

A layer system nickel/palladium/gold was deposited on the copper conductor tracks of a circuit board by the process of the invention.

The nickel layer having a thickness of about 5 μm was deposited autocatalytically by means of a commercial bath. For the subsequent deposition of palladium by charge exchange, a bath containing 100 mg/l of palladium as palladium sulfate, 50 g/l of sulfuric acid, 10 mg/l of copper as copper sulfate and 10 mg/l of citric acid was used. The molar ratio of palladium to sulfuric acid was thus about 1:540. The pH of this bath was less than 1. Firmly adhering, homogeneous layers which had a low porosity were obtained on the nickel intermediate layer after contact times of the palladium bath at room temperature of 5, 10 and 15 minutes. A final gold covering layer having a thickness of <0.1 μm was applied to these layers by charge exchange.

The finished layer system displayed excellent multiple solderability and bondability, both with aluminum wire and with gold wire, even at elevated thermal stress (e.g. 4 hours at 155° C.).

### EXAMPLE 2

Example 1 was repeated using a palladium bath containing 100 mg/l of palladium as palladium sulfate, 100 g/l of phosphoric acid and 50 mg/l of copper as copper sulfate. The molar ratio of palladium to phosphoric acid was thus about 1:1100. The bath had a pH of <1. This palladium bath, too, gave the same positive layer properties as in Example 1.

1. A process for applying a functional layer to a substrate metal, with the functional layer comprising, starting from the metal surface, a nickel or nickel alloy layer, a palladium layer and, if desired, a gold or gold alloy layer which are each deposited using appropriate coating baths, characterized in that the nickel or nickel alloy layer is deposited autocatalytically, the palladium layer is deposited by charge exchange and the gold or gold alloy layer is likewise deposited by charge exchange or autocatalytically, with the bath for deposition of the palladium layer comprising not only a palladium salt but also an inorganic compound of at least one of the elements copper, thallium, selenium and tellurium.

2. The process as claimed in claim 1, characterized in that the coating bath for the deposition of the palladium layer by charge exchange comprises at least one palladium salt having an inorganic or organic anion selected from the group consisting of palladium sulfate, palladium nitrate, palladium chloride and palladium acetate and also an acid matrix comprising at least one mineral acid selected from the group consisting of sulfuric acid, nitric acid, phosphoric acid and hydrochloric acid.

3. The process as claimed in claim 2, characterized in that the molar ratio of palladium to the mineral acid or acids is in the range from 1:500 to 1:2000.

4. The process as claimed in claim 3, characterized in that the deposition of the palladium layer is carried out at a temperature of the coating bath in the range from room temperature to 70° C. and at a pH in the range from 0 to 4.

5. The process as claimed in claim 4, characterized in that the deposition of the palladium layer is carried out at a temperature of the coating bath of from 25 to 50° C.

6. The process as claimed in claim 1, characterized in that the contact time of the coating bath for palladium is in the range from 1 to 20 minutes.

7. The process as claimed in claim 1, characterized in that the substrate metal forms the conductor tracks of an electronic circuit board and is selected from among copper, copper alloys and other conductive materials.

8. The process as claimed in claim 1, characterized in that the nickel alloy is a nickel/boron, nickel/phosphorus, nickel/iron/phosphorus, nickel/phosphorus/tungsten, nickel/cobalt/phosphorus or a nickel/tungsten alloy.

9. The process as claimed in claim 1, characterized in that the gold layer having a purity of greater than 99% is deposited from a conventional charge exchange bath and is additionally thickened further to a desired thickness by means of known autocatalytic processes.

10. A palladium bath for the deposition of a palladium layer on a nickel layer by charge exchange by means of the process as claimed in claim 1, characterized in that the bath contains the following components:
a) from 10 to 1000 mg/l of palladium from at least one palladium salt having an inorganic or organic anion selected from the group consisting of palladium sulfate, palladium nitrate and palladium acetate,
b) from 5 to 500 g/l of at least one mineral acid selected from the group consisting of sulfuric acid, nitric acid and phosphoric acid and
c) from 1 to 200 mg/l of at least one of the elements copper, thallium, selenium and tellurium from inorganic compounds of these elements.

11. The palladium bath as claimed in claim 9 which contains from 1 to 200 g/l of a complexing agent for nickel and/or palladium selected from the group consisting of hydroxycarboxylic acids with and without a functional mercapto group and amine compounds to improve the deposition performance of the electrolyte and the bath stability.
